(19) United States
(12) Patent Application Publication
(10) Pub. No.: US 2026/0264790 A1
(43) Pub. Date: Sep. 10, 2026

(54) FOLDABLE CRUISE PEDAL

(71) Applicant: Guangzhou Issyzone Technology Co.,Limited, Guangzhou (CN)

(72) Inventors: ZHUO JIA, Guangzhou City (CN); TAIPING YANG, Guangzhou City (CN)

(21) Appl. No.: 19/230,462

(22) Filed: Jun. 6, 2025

(30) Foreign Application Priority Data
Mar. 4, 2025 (CN) 202520363252.4

(51) Int. Cl. B62J 25/00

(52) U.S. Cl. CPC B62J 25/00

(57) ABSTRACT

Disclosed is a foldable cruise pedal, including: a fixed pedal, configured to connect to a pedal bracket; a hinge member, disposed on a side of the fixed pedal; a movable pedal, hinged to the fixed pedal via the hinge member; and a locking mechanism, disposed on an opposite side of the fixed pedal, configured to secure the fixed pedal and the movable pedal. Beneficial effects of the present application: By providing a hinge member connecting the fixed pedal and the movable pedal, the user may flip and fold the movable pedal onto the fixed pedal, and secure the movable pedal via the locking mechanism, thereby reducing the stepping area of the pedal. Alternatively, when the user needs to increase the stepping area, the movable pedal may be unfolded to form a wide pedal together with the fixed pedal, which can cooperate with the original vehicle pedal for use.

### TE CROSS REFERENCE TO RELATED APPLICATIONS

The present disclosure claims the priority of Chinese Patent Application No. 202520363252.4 filed on 03/04/2025. All the above are hereby incorporated by reference in their entirety.

### TECHNICAL FIELD

The present application relates to the technical field of motorcycle accessories, and particularly to a foldable cruise pedal.

### BACKGROUND

Motorcycle cruise pedals are comfort-oriented designs used to support a rider's feet. Existing cruise pedals generally have excessively small stepping areas, causing a significant portion of the foot to remain unsupported during use. Prolonged use may further exacerbate discomfort.

### SUMMARY

To address the above issues, the present application proposes a foldable cruise pedal, aiming to resolve the problem that conventional cruise pedals cannot flexibly adjust their stepping area.

In order to address the aforementioned technical solution, the technical solution of the present application is as follows.

A foldable cruise pedal includes:

a fixed pedal, configured to connect to a pedal bracket;

a hinge member, disposed on a side of the fixed pedal;

a movable pedal, hinged to the fixed pedal via the hinge member; and

a locking mechanism, disposed on an opposite side of the fixed pedal, configured to secure the fixed pedal and the movable pedal.

In some implementations, the hinge member includes a pivot shaft installed at a junction between the fixed pedal and the movable pedal.

In some implementations, the pivot shaft is provided with a torsion spring installed therein.

In some implementations, the junction between the fixed pedal and the movable pedal is further provided with respective magnets.

In some implementations, a surface of the fixed pedal is provided with first protrusions, and a surface of the movable pedal is provided with second protrusions spaced apart from and staggered in space relative to the first protrusions.

In some implementations, the locking mechanism comprises a dovetail groove disposed at a side edge of the fixed pedal; a locking shaft is inserted into the dovetail groove, a surface of the locking shaft being provided with a limiting block protruding from an opening of the dovetail groove; a compression spring is disposed at an end of the dovetail groove proximate to the pedal bracket, an end of the locking shaft being connected to the compression spring; and clasp teeth are disposed at a side edge of the movable pedal, wherein when the compression spring is in an unforced state, the limiting block engages with the clasp teeth.

In some implementations, the limiting block is wedge-shaped, having a width that gradually increases from top to bottom on a side distal to the compression spring.

In some implementations, the dovetail groove is internally provided with a limiting screw; the locking shaft is provided with a limiting groove at a middle portion thereof to accommodate the limiting screw, wherein a width of the limiting groove is greater than a diameter of the limiting screw.

In some implementations, the pedal bracket comprises a tube clamp, a crank, and a connecting block sequentially connected to each other; and a damping gasket is installed at a connection between the fixed pedal and the connecting block.

Beneficial effects of the present application: By providing a hinge member connecting the fixed pedal and the movable pedal, the user may flip and fold the movable pedal onto the fixed pedal, and secure the movable pedal via the locking mechanism, thereby reducing the stepping area of the pedal. Alternatively, when the user needs to increase the stepping area, the movable pedal may be unfolded to form a wide pedal together with the fixed pedal, which can cooperate with the original vehicle pedal for use.

### BRIEF DESCRIPTION OF THE DRAWINGS

FIG. 1 is a schematic diagram showing an unfolded state of the foldable cruise pedal disclosed in an embodiment of the present application;

FIG. 2 is a schematic diagram showing a folded state of the foldable cruise pedal disclosed in the embodiment of the present application;

FIG. 3 is an exploded view of the foldable cruise pedal disclosed in the embodiment of the present application;

FIG. 4 is a partial enlarged view of the foldable cruise pedal during an unfolding process disclosed in the embodiment of the present application.

1 - fixed pedal; 2 - movable pedal; 3 - pivot shaft; 4 - torsion spring; 5 – magnet; 6 - first protrusion; 7 - second protrusion; 8 - dovetail groove; 9 - locking shaft; 10 - limiting block; 11 - compression spring; 12 - clasp teeth; 13 - limiting screw; 14 - limiting groove; 15 - tube clamp; 16 - crank; 17 - connecting block; 18 - damping gasket.

### DETAILED DESCRIPTION

In order to enable the purpose, technical solution and advantages of the present disclosure to be clearer and more explicit, the contents of the present disclosure are described in further detail below in connection with the attached drawings and specific embodiments. It is to be understood that the specific embodiments described herein are only for the purpose of explaining the present disclosure and are not a limitation of the present disclosure. It should also be noted that, for ease of description, only some, but not all, of the elements relevant to the present disclosure are shown in the attached drawings.

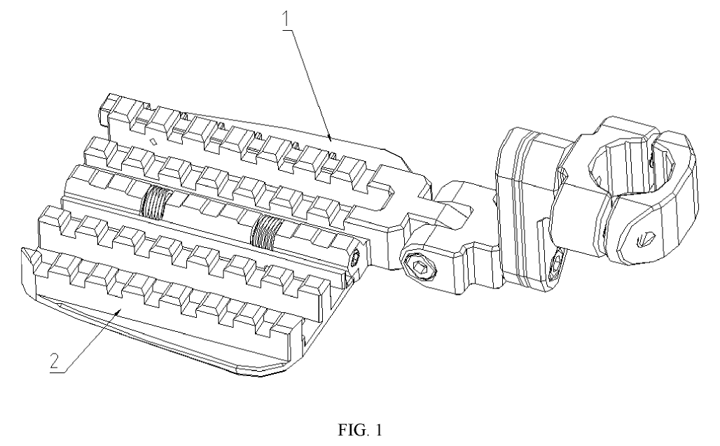

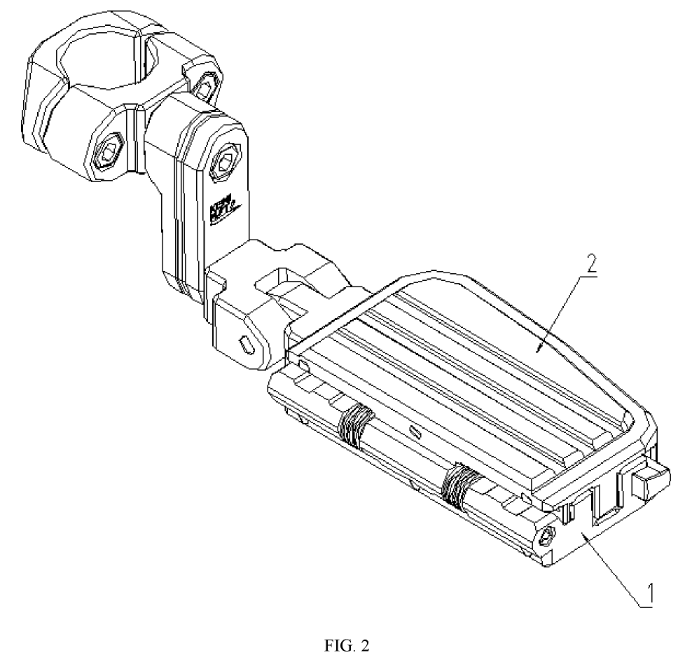

Proposed in the present embodiment is a foldable cruise pedal, as shown in FIGS. 1 and 2, including:

a fixed pedal 1, configured to connect to a pedal bracket;

a hinge member, disposed on a side of the fixed pedal 1;

a movable pedal 2, hinged to the fixed pedal 1 via the hinge member; and

a locking mechanism, disposed on an opposite side of the fixed pedal 1, configured to secure the fixed pedal 1 and the movable pedal 2.

In the present embodiment, by providing a hinge member connecting the fixed pedal 1 and the movable pedal 2, the user may flip and fold the movable pedal 2 onto the fixed pedal 1, and secure the movable pedal 2 via the locking mechanism, thereby reducing the stepping area of the pedal. Alternatively, when the user needs to increase the stepping area, the movable pedal 2 may be unfolded to form a wide pedal together with the fixed pedal 1, which can cooperate with the original vehicle pedal for use.

In the present solution, the aforementioned hinge member may adopt any type of hinge structure, such as a butt hinge. In one example, the hinge member includes a pivot shaft 3 installed at a junction between the fixed pedal 1 and the movable pedal 2. Correspondingly, the junction between the fixed pedal 1 and the movable pedal 2 is provided with matching shaft sleeves configured to respectively receive two ends of the pivot shaft 3. In some implementations, the pivot shaft 3 is internally provided with a torsion spring 4. When the user folds the movable pedal 2 onto the fixed pedal 1 and secures it via the locking mechanism, the torsion spring 4 stores elastic potential energy. Upon the user actively releasing the locking mechanism, the torsion spring 4 releases the elastic potential energy to drive the movable pedal 2 to snap back to its original position, thereby aligning the movable pedal 2 with the fixed pedal 1.

Optionally, the junction between the fixed pedal 1 and the movable pedal 2 is further provided with respective magnets. When the movable pedal 2 is in the unfolded state (wide pedal configuration), the magnets 5 at the junction between the fixed pedal 1 and the movable pedal 2 magnetically attract each other, serving as an auxiliary securing means for the movable pedal 2 to ensure integral structural rigidity of the pedal assembly.

A surface of the fixed pedal 1 is provided with first protrusions 6, and a surface of the movable pedal 2 is provided with second protrusions 7 spaced apart from and staggered in space relative to the first protrusions 6. In this optional embodiment, the arrangement of the first protrusions 6 and second protrusions 7 not only ensures sufficient frictional force across the pedal surface in the wide pedal configuration, but also, by being spaced apart and staggered in space relative to each other, prevents kinematic interference between the movable pedal 2 and the fixed pedal 1 during folding, thereby enabling complete folding operation.

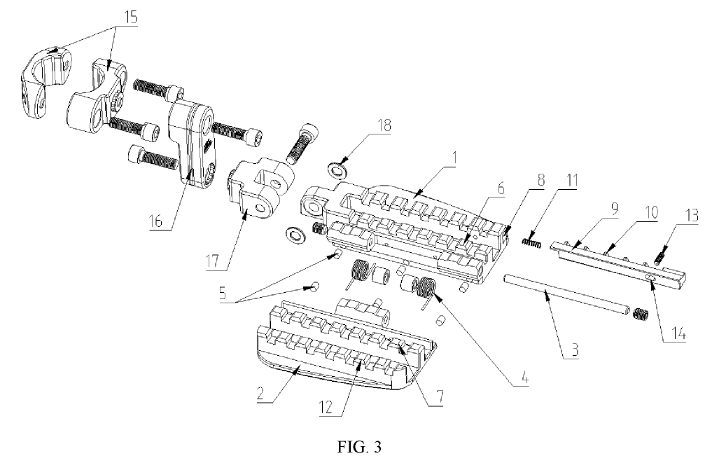

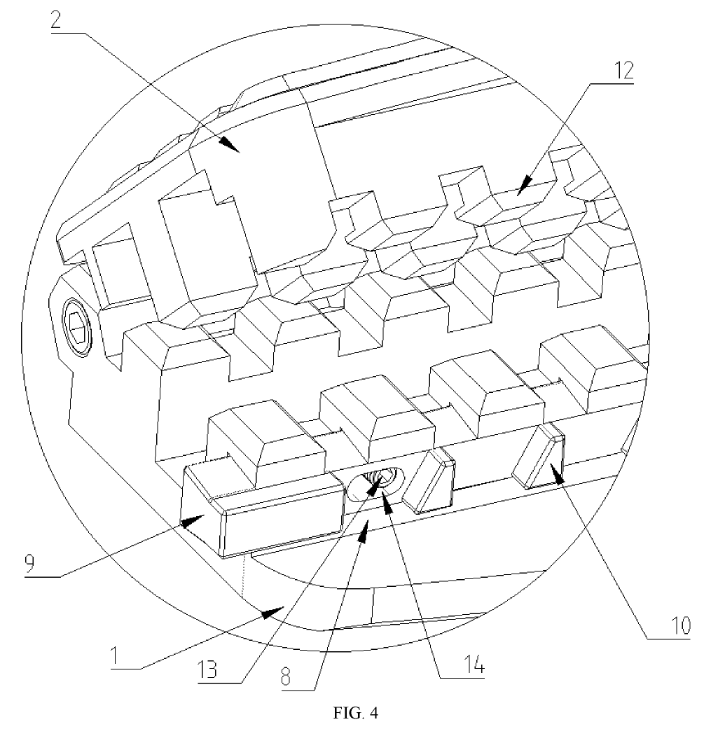

In an implementation, as shown in FIGS. 3 and 4, the locking mechanism includes a dovetail groove disposed at a side edge of the fixed pedal 1; a locking shaft 9 is inserted into the dovetail groove 8, a surface of the locking shaft 9 being provided with a limiting block 10 protruding from an opening of the dovetail groove 8; a compression spring 11 is disposed at an end of the dovetail groove 8 proximate to the pedal bracket, an end of the locking shaft 1 being connected to the compression spring 11; and clasp teeth 12 are disposed at a side edge of the movable pedal 2, wherein when the compression spring 11 is in an unforced state, the limiting block 10 engages with the clasp teeth 12. In the above embodiments, the dovetail groove 8 and locking shaft 9 serve as core components of the locking mechanism. To release the locking state, the user presses the head of the locking shaft 9, causing the locking shaft 9 to progressively retract into the dovetail groove 8. Simultaneously: the compression spring 11 is compressed to store elastic potential energy; the limiting block 10 moves synchronously with the locking shaft 9, transitioning from an engaged state with the clasp teeth 12 to a disengaged state, thereby unlocking the mechanism. Under this condition, the torsion spring 4 releases its elastic potential energy to drive the movable pedal 2 to snap back to its original position, forming the wide pedal configuration with the fixed pedal 1. Additionally, when the user's finger releases the head of the locking shaft 9, the compression spring 11 releases the stored elastic potential energy, driving the locking shaft 9 to return to its original position. As a further preferred embodiment of the present solution, the limiting block 10 is wedge-shaped, with a width gradually increasing from top to bottom on the side distal to the compression spring 11. During folding of the movable pedal 2 onto the fixed pedal 1, the clasp teeth 12 on the movable pedal 2 press against the top of the wedge-shaped limiting block 10; as the user applies force, the clasp teeth 12 gradually descend while compressing the compression spring 11 to store elastic potential energy; when the clasp teeth 12 reach the bottom of the limiting block 10, the compression spring 11 releases the stored energy to drive the locking shaft 9 back to its original position, completing re-locking. Additionally, as shown in FIG. 4, multiple sets of limiting blocks 10 and clasp teeth 12 may be provided. Upon failure of one set of the limiting blocks 10 and the clasp teeth 12, the remaining sets thereof maintain engagement, thereby enhancing the reliability of the locking mechanism.

To prevent the locking shaft 9 from disengaging from the opening of the dovetail groove 8, in one embodiment, the dovetail groove 8 is internally provided with a limiting screw 13. The locking shaft 9 is provided with a limiting groove 14 at its middle portion to accommodate the limiting screw 13, wherein a width of the limiting groove 14 is greater than a diameter of the limiting screw 13. This configuration restricts the locking shaft 9 to limited sliding within the dovetail groove 8, with the specific width determined by design requirements and not further defined herein.

Optionally, the pedal bracket includes a tube clamp 15, a crank 16, and a connecting block 17 sequentially connected. A damping gasket 18 is installed at a connection between the fixed pedal 1 and the connecting block 17. The tube clamp 15 is configured to mount the device onto a vehicle frame; the crank 16 is replaceable (e.g., with a longer version) to accommodate users of varying heights; as a basis for a generic configuration of this device, the connecting block 17, preferably a hinged structure, couples the fixed pedal 1 to the crank 16; a thickness of the damping gasket 18 is adjustable to increase friction between the fixed pedal 1 and the connecting block 17.

It should be noted that the foldable cruise pedal disclosed in this embodiment is an optional accessory independent of the original vehicle pedal. It can be installed on the vehicle simultaneously with the original pedal, and its installation position is adjustable according to user requirements (e.g., using the aforementioned tube clamp 15 to mount the device onto the vehicle), without replacing the original pedal. In addition to front-rear folding, the pedal can also be folded inward. Therefore, when the user utilizes only the original pedal, the disclosed pedal can be folded inward via the connecting block 17 to reduce its volume for compact storage.

The above embodiments are only intended to illustrate the technical concepts and features of the present disclosure, and are intended to enable persons of ordinary skill in the art to understand the contents of the present disclosure and to implement them accordingly, and are not intended to limit the scope of protection of the present disclosure. Any equivalent changes or modifications made in accordance with the substance of the contents of the present disclosure should be covered by the scope of protection of the present disclosure.

1. A foldable cruise pedal, comprising:
a fixed pedal, configured to connect to a pedal bracket;
a hinge member, disposed on a side of the fixed pedal;
a movable pedal, hinged to the fixed pedal via the hinge member; and
a locking mechanism, disposed on an opposite side of the fixed pedal, configured to secure the fixed pedal and the movable pedal.

2. The foldable cruise pedal according to claim 1, wherein the hinge member comprises a pivot shaft installed at a junction between the fixed pedal and the movable pedal.

3. The foldable cruise pedal according to claim 2, wherein the pivot shaft is provided with a torsion spring installed therein.

4. The foldable cruise pedal according to claim 1, wherein the junction between the fixed pedal and the movable pedal is further provided with respective magnets.

5. The foldable cruise pedal according to claim 1, wherein a surface of the fixed pedal is provided with first protrusions, and a surface of the movable pedal is provided with second protrusions spaced apart from and staggered in space relative to the first protrusions.

6. The foldable cruise pedal according to claim 1, wherein the locking mechanism comprises a dovetail groove disposed at a side edge of the fixed pedal; a locking shaft is inserted into the dovetail groove, a surface of the locking shaft being provided with a limiting block protruding from an opening of the dovetail groove; a compression spring is disposed at an end of the dovetail groove proximate to the pedal bracket, an end of the locking shaft being connected to the compression spring; and clasp teeth are disposed at a side edge of the movable pedal, wherein when the compression spring is in an unforced state, the limiting block engages with the clasp teeth.

7. The foldable cruise pedal according to claim 6, wherein the limiting block is wedge-shaped, having a width that gradually increases from top to bottom on a side distal to the compression spring.

8. The foldable cruise pedal according to claim 6, wherein the dovetail groove is internally provided with a limiting screw; the locking shaft is provided with a limiting groove at a middle portion thereof to accommodate the limiting screw, wherein a width of the limiting groove is greater than a diameter of the limiting screw.

9. The foldable cruise pedal according to claim 1, wherein the pedal bracket comprises a tube clamp, a crank, and a connecting block sequentially connected to each other; and a damping gasket is installed at a connection between the fixed pedal and the connecting block.
